(19) United States
(12) Patent Application Publication
(10) Pub. No.: US 2008/0118070 A1
(43) Pub. Date: May 22, 2008

(54) Open and distributed systems to provide secure email service

(75) Inventors: Tet Hin Yeap, Ottawa (CA); Thomas Anton Goeller, Muenchen (DE)

Correspondence Address: Tet Hin Yeap, 675 Roosevelt Avenue, Ottawa, ON, K2A 2AB, omitted

(73) Assignee: 6580874 Canada Inc., Ottawa (CA)

(21) Appl. No.: 11/601,872

(22) Filed: Nov. 20, 2006

(51) Int. Cl. H04L 9/08; H04L 9/30

(52) U.S. Cl. 380/282; 380/44

(57) ABSTRACT

A system to ease secure email communication by providing a unique email address of a user's choice, along with a private and public key pair which are generated and then associated with the email address. Along with the key pair, an plug-in to her preferred mail client is delivered to the user. The plug-in will allow for automatic retrieval of recipient's public keys from a server and encryption of mails to recipients whose email address is associated with a public key. Also, the email plug-in will perform automatic decryption of incoming mail, if necessary, plus additional functionality based on the existence of public and private keys.

### FIELD OF INVENTION

The present invention relates to a scalable and distributed system to allow arbitrary users in different organizations and computer domains to communicate securely via email, and more particularly to the application of web-based public key infrastructure to enable transmission of e-mail securely over internet.

### BACKGROUND OF THE INVENTION

The most widespread method to communicate securely via email is based on certificates and public/private key pairs as presented in U.S. Pat. No. 6,061,448. Using this method, a user has to perform the following steps to be able to receive secured, i.e. encrypted email:
Contact a Certificate Authority to request a certificate and a public/private key pair.
Authenticate himself with the Certificate Authority—often, the Certificate Authority requires authentication in person to ensure that the certificate is received by the natural or legal person it is issued for.
The Certificate Authority issues a certificate for the requestor and signs it with its own private key. Thus, using the public key of the Certificate Authority, the integrity of the issued certificate can be proven.
The Certificate Authority also generates a public/private key pair and associates it with the certificate of the requestor.
The private key is encoded with a password entered by the requester.
Certificate, private and public key are given to the requestor. The private key is deleted at the Certificate Authority.
Certificate and public key are stored on one or several secure servers accessible to the public or a desired user group.

When another user (sender) wants to send a secure email to the above user (recipient) for the first time, she has to perform the following steps:
Find out a link to the recipient's public key associated with his email. Usually, this link is distributed by the recipient to potential communication partners, e.g. in a mail signature. Alternatively, the public key can be looked up on a PGP key server, as described in U.S. Pat. No. 6,836,765. However, since PGP servers synchronize user level entries, this is not believed to scale for billions of secure email users.
An alternative to above, an LDAP (Light Weight Directory Accessible Platform) central server as introduced could be used to store user's public certificates and be available to senders who want to send secure e-mail to the recipients, as presented in a paper “Using LDAP Directories for Management of PKI Processes” published in Proceedings of Public Key Infrastructure: First European PKI Workshop: Research and Applications, EuroPKI 2004, Volume 3093, Pages 126-134, June 2004. However, this method is typically used in intranet situation due to security weakness in LDAP server, as presented in a paper “Deficiencies In LDAP When Used TO Support Public Key Infrastructure” published in Communications of the ACM, Volume 46, Issue 3, Pages 99-104, March 2003. Note that the term PKI used in this invention disclosure stands for Public Key Infrastructure. A distributed database system as introduced in U.S. Pat. No. 7,123,722 could also be used to store user's public certificates and be available to senders who want to send secure e-mail to the recipients. This distributed database system has the similar security problem as a LDAP server.
Look up the recipient's public key using this link.
Store the recipient's public key in a file.
Import the recipient's public key into the sender's certificate store. The certificate store may be a certificate store provided by the operating system or an application specific certificate store provided by a dedicated encryption/decryption application or by the mail client application.
Encrypt the mail with the recipient's public key in one of the following ways:
   Write the mail body in a file and encrypt this file along with other attachments in an application unrelated to the mail client. Then attach the encrypted file produced by this application to a mail from sender to recipient.
   Manually trigger a function of the mail client to encrypt the mail to the recipient using the recipient's public key.
   On sending, the mail client automatically checks the certificate store whether a public key for the mail recipient is available. If yes, the mail client either offers a choice to the sender—encrypt mail to recipient or not—or encrypts the mail to recipient automatically.
Send the mail to recipient.

This procedure has the following disadvantages:
The user wanting to receive secure email has to actively address a Certificate Authority, often at significant cost to himself.
The user has to prove his identity to the Certificate Authority, which involves costly and time-consuming procedures—e.g. physical travel, identification by postal services.
Unless sender and recipient both belong to an organization with a common PKI infrastructure, many steps have to be performed to enable potential senders to send encrypted email to a recipient.

In consequence, inter-organizational secure email sees a slow adaptation rate, and thus most emails are still sent in the clear, easing eavesdropping and making it harder to fight spam. The effort involved with establishing the identity of a natural or legal person which leads to above disadvantages is neither necessary nor desired in many applications of email communication.

In U.S. Pat. Nos. 6,154,543 and 6,292,895, a public key cryptosystem with roaming user capability within a network that allows secure transmission of e-mails between users of the system. A client machine generates and stores an encrypted private key on a central encryption server. A user may then access the encrypted private key from any client machine located on the network and decrypt it using a passphrase, thus giving the user roaming capability. The private key may then be used to receive and decrypt any email encrypted using his public key. A user can generate a digital message, encrypt it with a client recipient's public key, and transmit it to the recipient's email server from any client machine on the network. This approach is not entirely satisfactory because a user needs to read an e-mail, he has to log on to the central encryption server to get his private key, and thus this secure email system will not scale for billions of secure email users.

Another technique known as Identity Base Encryption (IBE) scheme was introduced in U.S. Pat. Nos. 6,886,096 and 7,003,117 to simplify the complicated process of dealing with certificate. IBE is a public-key cryptosystem where any string is a valid public key. In particular, email addresses and dates can be public keys. A trusted third party, called the Private Key Generator (PKG), generates the corresponding private keys. The PKG publishes a “master” public key, and keep the corresponding master private key in a secret store. Given the master public key, any party can compute a public key corresponding to a user by combining the master public key with the identity value. To obtain a corresponding private key, the party authorized to use the user's public key contacts the PKG, which uses the master private key to generate the private key for the party. As a result, parties may encrypt messages with no prior distribution of public keys between individual participants. This is extremely useful in cases where pre-distribution of public and private keys is inconvenient due to technical restraints. This approach is not entirely satisfactory because the PKG must operate in a highly trusted manner, as it is capable of generating any user's private key and may therefore decrypt messages without authorization.

### SUMMARY OF THE INVENTION

The present invention consists of a system that lets the user obtain a unique email address of her choice, along with a private and public key pair which is generated upon request of the email address. Along with the key pair, an plug-in to her preferred mail client is delivered to the user. The plug-in will allow for automatic retrieval of recipient's public keys from a server and encryption of mails to recipients whose email address is associated with a public key. Also, the email plug-in will perform automatic decryption of incoming mail, if necessary, plus additional functionality based on the existence of public and private keys. The invention also covers the case when the user wants to add secure communication functionality to an existing email address in her possession.

### BRIEF DESCRIPTION OF THE DRAWINGS

The invention will now be described by way of example only, and with reference to the accompanying drawings, in which:

FIG. 1. is a schematic representation of the System Components in a Data Center offering Secure Email Services.

FIG. 2. A sample form with basic user information to create an secure email account.

FIG. 3. Transmission of secure email in a public network.

FIG. 4. Reception of secure email in a public network.

FIG. 7. Registration of a new public key with key servers

FIG. 8. Retrieval of a public key from key servers

### DETAILED DESCRIPTION OF THE INVENTION

The first embodiment of the invention consists of a system that lets a user to obtain a unique email address of her choice, along with a private and public key pair which is generated upon request of the email address.

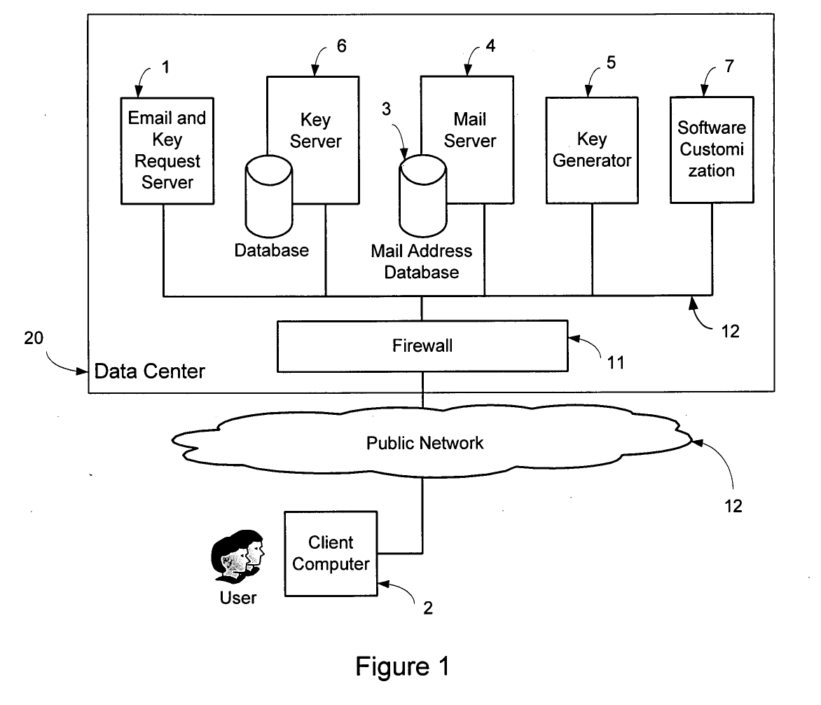

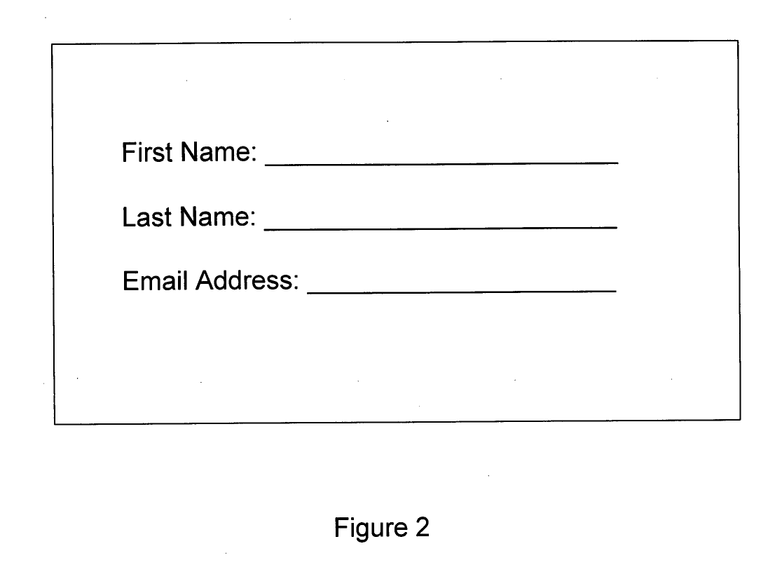

Referring now to FIG. 1, the starting point of a typical service based on this invention is a Web Accessible Server 1. In typical configuration, the Web Accessible Server 1 is located in a Data Center 20 and connected to an internal private network 12 protected by a firewall 11. A user who wants to participate in the service connects from a Web client running in Client Computer 2 to the Server 1. Server 1 will offer the user a form, as shown in FIG. 2, to enter a desired email address under a domain operated by the service provider.

Once the user has entered her request for an address, the server checks the desired email address against a Database 3 of existing email addresses. If the email does not exist yet, the user is requested to enter a password for accessing the mails and the public and the private keys to be generated. The Server 1 enters the email address into the Database 3 of the Mail Server 4, and sends a request to a Key Generator 5 which generates a private and public key pair. Otherwise, an exception is generated saying that the email address exists and the request to add the email address to the database may be illegal. The case for users with legitimate e-mail address in the Mail Server 4 will be described later in the second embodiment of the invention.

The email address and the public key are then entered on Key Server 6. On the Key Server 6, the email address of the user will be stored along with the public key. The public key will be signed with the private key of the key server to make sure that the public key could be checked by the mail client plug-in software of the user for the key authenticity.

The email address, the public and the private key are also used to generate a custom software installation package by a Software Customization module 7. The custom software installation package generated will then be offered to the user for download to the Client Computer 2. After downloading the software package, the user will be asked to execute the software installation package.

The software installation package will install at least the following components on the Client Computer 2:
A mail client plug-in whose functionality will be described in the following.
A public/private key pair associated with the email address the user has obtained. Access to this key pair requires entry of a password. Initially this is the password entered by the user during the secure email address registration.

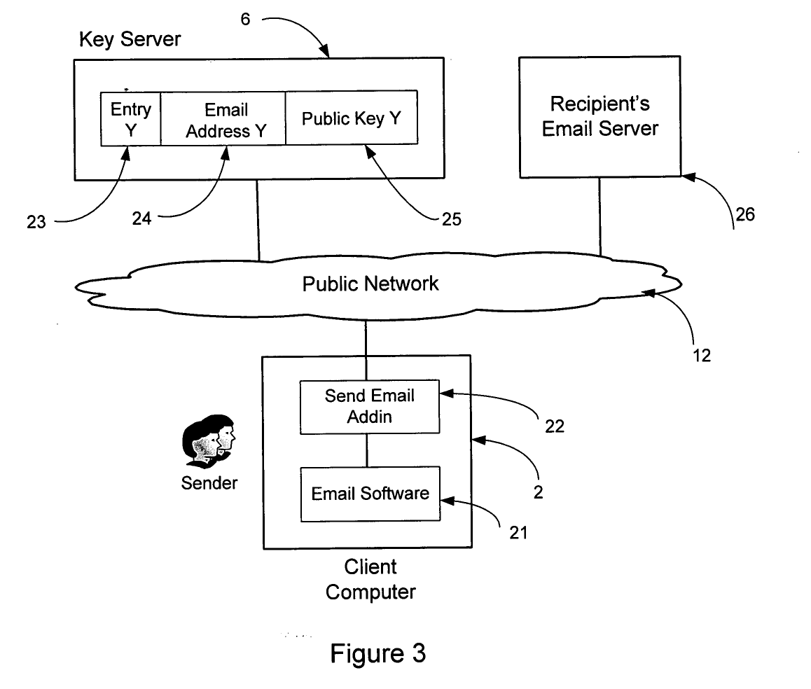

Refer to FIG. 3 for the following description. When the above user (sender) wants to send out an email to another user (recipient) from the Client Computer 2—the case when we have several recipients is analogous—the sender composes the mail in the client computer 2 using the Email Software 21, as usual. When the sender presses the “Send” button, the Send Mail Plug-in 22 will do the following:
Contact the Key Server 6 to find out whether a key is associated with the recipient's email address 24.
If no, the email will be sent unencrypted. If yes, the Send Mail Plug-in 22 will retrieve the recipient's Public Key 25 from the Key Server 6. The Send Mail Plug-in 22 will encrypt the message to the recipient with the recipient's Public Key 25. Then the email will be sent to the recipient's Email Server 26

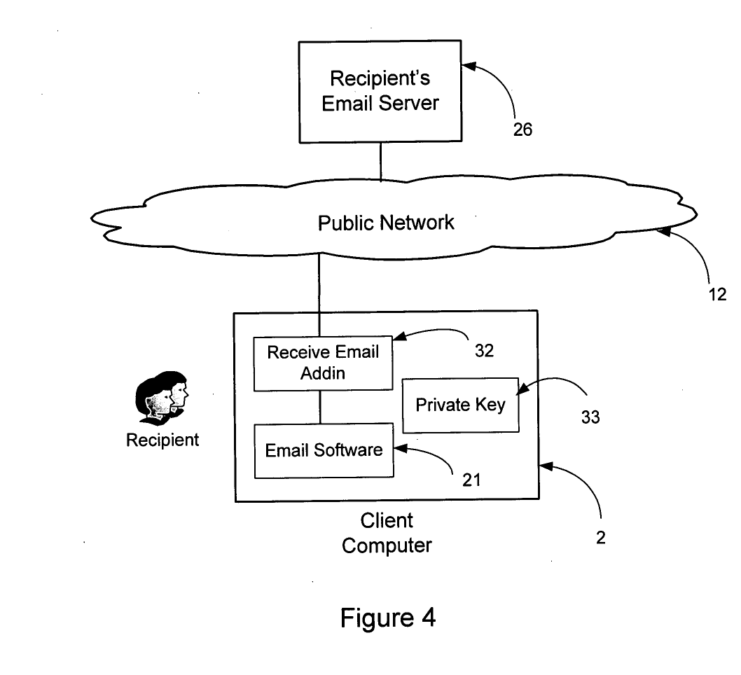

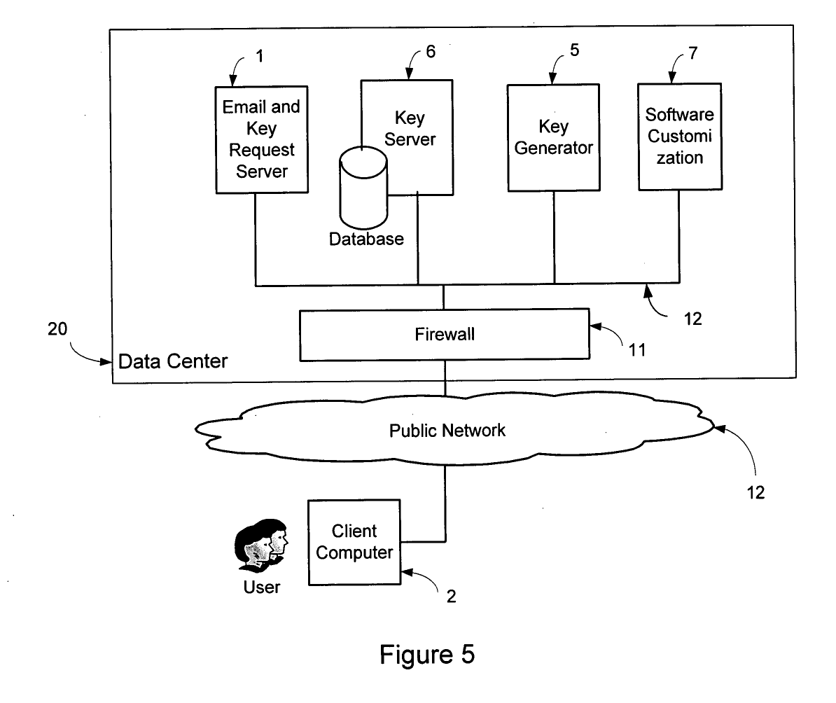

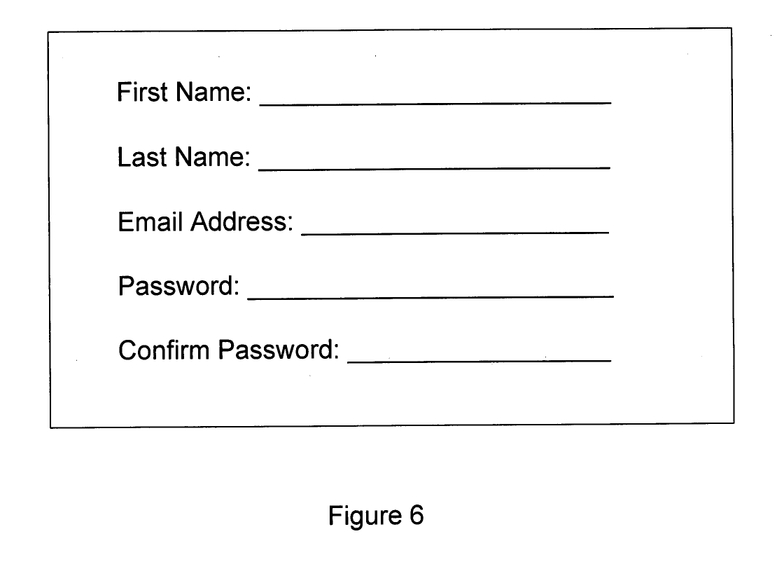

Refer to FIG. 4 for the following description. When the above user receives an encrypted email from the Recipient's Email Server 26, the Receive Mail Plug-in 32 will do the following:
Ask the user for the password to access the Private Key 33. It is up to the security policy whether this has to happen every time when a mail shall be decrypted or only the first time after the Email Software 21 has started.
Decrypt the received mail with the user's Private Key 33

The Name Entry 23 in the database of Key Server 6 is optional. It is mainly used for maintenance and search purposes.

It is important to note that the number of public key searches per unit time from registered users in Key Server 6 would be huge when proposed system is proposed. The time required to search for a public key given the e-mail address of the user should be minimized so that a user does not have to wait for a long time for the Key Server 6 to respond to send an encrypted e-mail. Therefore a good public key search engine is needed. For this purpose, a well known Hash Table that associates e-mail address with the associated public key to speed up the search could be used. It works by transforming the e-mail address using a hash function into a hash, a number that the hash table uses to locate the public key. Hash table search technique provides constant-time lookup on average, regardless of the number of entries in the table.

The second embodiment of the invention consists of a system that lets a user to add secure communication functionality to an existing email address in her possession, along with a private and public key pair which is generated upon request of secure e-mail service. It could be applied to email addresses under the domain operated by the same or different service provider if desired.

Refer now to FIG. 5 for the description of the embodiment. A user who wants to participate in the service connects from a Web client running in Client Computer 2 to the Server 1. Server I will offer the user a form as shown in FIG. 6, to enter the user's first name, last name, existing email address, and the password for accessing the mails and the public and the private keys to be generated. The confirmation password is also entered to make sure that the password entered is correct.

Once the user has entered the requested information, the Server 1 sends a request to a Key Generator 5 which generates a private key, public key and an activation code for the desired email address. The email address, the public key and the activation code are then entered on Key Server 6. On the Key Server 6, the email address of the user will be stored along with the public key. The public key will be signed with the private key of the key server to make sure that the public key could be checked by the mail client plug-in software for the key authenticity. At this stage, the entry containing the email address along with the associated public key is still inactive. It will remain inactive until the user has activated it.

The email address, the public, the private key and activation code are used to generate a custom software installation package by a Software Customization module 7. The custom software installation package generated will then be offered to the user for download to the Client Computer 2. After downloading the software package, the user will be asked to execute the software installation package.

To avoid any illegal email address entry and its associated public key in Key Server 6, the activation code during key generation generated earlier will be send to the user by email to his registered email address. Upon receiving the email, the user enters the activation code to activate software installation package. Upon activation, the software installation package will install at least the public/private key pair associated with the email address on the Client Computer 2. Access to this key pair requires entry of a password. Initially this is the password entered by the user during the secure email service registration. The plug-in software generates a hash code from the activation code after it has been activated and send the hash code and the e-mail address to Key Server 6. Key Server 6 compared the hash code of the activation code stored in the database associated with the e-mail address with the hash code received. If these two hash codes are identical, Key Server 6 will activate the user's email address entry and the associated public key.

The same processes described in the first embodiment are applied when the user (sender) wants to send out an email to another user (recipient) from the Client Computer 2 or when the above user receives an encrypted email from the Recipient's email server.

Note that embodiments 1 and 2 of the invention could be combined into one if desired.

For simplicity, the key server 6 has been described as a single device so far. In the third embodiment of the invention, it can be extended as a redundant and distributed service to allow for better scaling and availability. But this is still not enough in the following cases:
1. When domain owners do want to have control over the public key infrastructure of users in their domain.
2. When users do not desire the service to be run by or be dependent on a single provider of public key information.

The third embodiment of the invention addresses these points by providing the following two extensions to the key server functionality. The first extension can be embodied by using the DNS service without modifications. The send mail plug-in described above can perform a DNS lookup for the recipient's domain or subdomain. Having obtained the IP address of the domain server, the mail agent can send a public key query for the recipient's email address to the domain server under a specified port. If a public key lookup service is configured under this domain, this service will return the public key associated with the email address in question or a response that no public key is associated with this email address. If no public key lookup service is configured under this domain, the requestor may give up on public key encryption or try an alternative provider of public key information, such as the one given below.

This second extension can be embodied by using a dedicated protocol. A user with any email address domain may obtain her public/private key pair from any provider. To make this scenario scalable and secure, a modified DNS service—called kDNS from now on—can be used for key requests. This service will operate with a different port and a different protocol attribute to distinguish it from the standard DNS service. If a new key pair is generated, the provider generating the keys will look up the key server responsible to distribute the public keys via kDNS. If the domain of the email address of the key requestor is already known to kDNS, the key provider will store the newly generated public key on the key server indicated by kDNS. If a public key already exists for this email address, the storing request will fail. If storing is successful, the key server will send an email to the address for which the key was generated. The mail shall contain plain text informing the recipient about the action performed and an encrypted attachment allowing the user to check that the correct public key was stored. The provider remembers the public key server and will occasionally ask the key server for the public key the provider stored on this key server. When this key is not identical to the public key the provider generated, further measures can be taken. The requests from provider to key server can be made through varying proxies to detect source-dependent responses. The key server remembers the provider who requested storage of the public key. When it turns out that a particular provider is not trustworthy, all keys submitted by that provider may be frozen or deleted. Additional security measures such as the use of tunneled connections between providers and key servers may be taken to reduce the probability that storage of keys which are not in the possession of the email address owner is requested.

If the domain of the email address of the key requestor is not yet known to kDNS, the provider can take up key server responsibility for the domain or can delegate this responsibility to another key server. If the domain owner has a kDNS enabled key server, the domain owner should be delegated key server responsibility for his domain. The kDNS protocol shall foresee re-delegations of keys of one domain from one key server to the other.

When a user requests key generation from a trustworthy provider, the kDNS protocol ensures that the correct public keys are found and delivered to requesters. Caching may be used to overcome outages of a part of the kDNS server hierarchy.

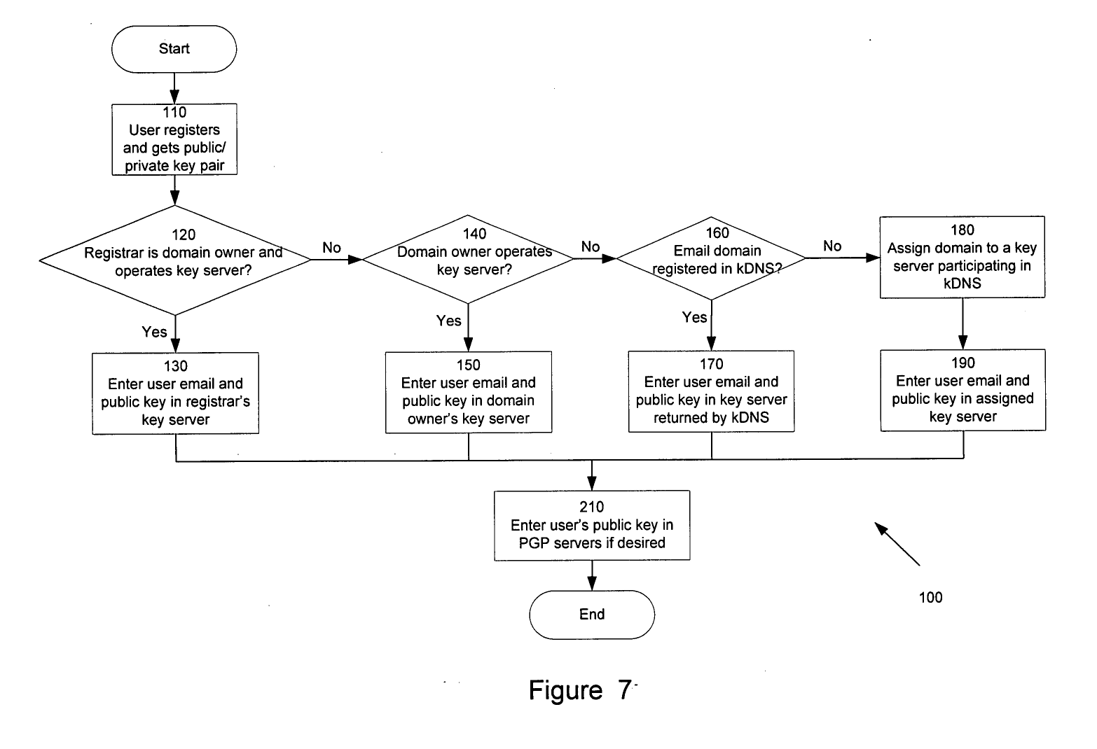

When key servers are used, refer to FIG. 7 with method 100 for registration of a new key. Once the user has registered with any registrar offering the service and a new key pair has been issued to the user, step 110 is completed and the public key of the user will be written to key server. If the registrar owns the domain of the user's email address and operates a key server for that domain (decision in step 120), the public key will be entered on this key server (step 130). If the registrar does not own the domain of the user's email address, but the domain owner operates a key server (decision in step 140), the public key will be entered on this key server (step 150). If the kDNS protocol returns a key server which is responsible for the user's email domain (decision in step 160), the user's public key will be entered on this key server (step 170). If no key server is responsible for the user's email domain yet (negative decision in step 160), the key serving responsibility for that domain has to be assigned to some key server (step 180) and the higher kDNS layers shall be informed. The user's public key is then entered on the assigned key server (step 190). If an additional publication of the user's public key on PGP key servers is desired, this can be done with an automatically generated certificate (step 210).

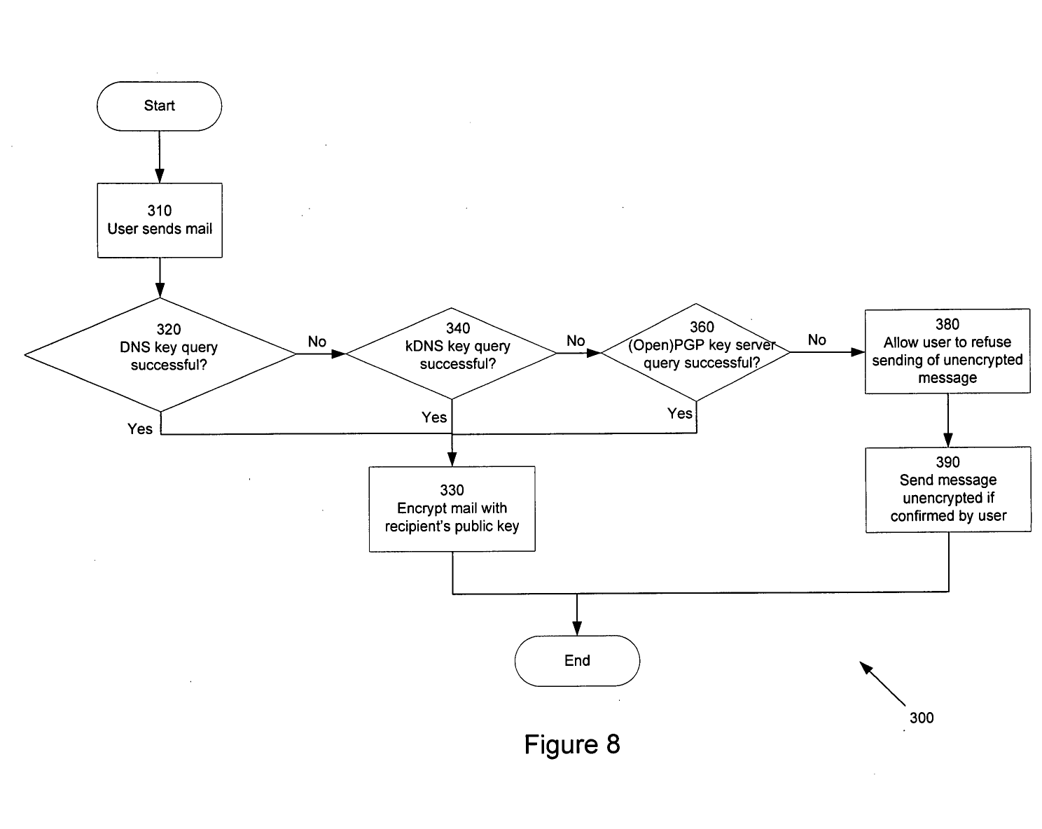

For queries to key servers, refer to FIG. 8 with method 200. When the security enabled send mail plug-in checks for the recipient's public key, it uses a DNS based query first (step 320). If the domain owner operates a key server under the defined port and if the recipient's email address has a public key associated with it, the recipient's public key will be returned. The send mail plug-in will then proceed to encrypt and send the mail (step 330). If the domain owner does not operate a key server under the defined port (negative decision in step 320), the send mail plug-in uses a kDNS query to find a key server to which the recipient's email domain has been assigned (step 340). If the domain has been assigned to a key server and if the recipient's email address has a public key associated with it, the recipient's public key will be returned. The send mail plug-in will then proceed to encrypt and send the mail (step 330). If the kDNS based key query does not yield a result, the mail user agent may try to obtain a public key from public or private PGP servers (step 350). If this key query returns a public key, the mail user agent will proceed to encrypt and send the mail (step 330). If all key queries are unsuccessful, the mail shall either not be sent to this recipient, or sent unencrypted (step 390) after the sender has confirmed that this is her desire (step 380), or send unencrypted without sender interaction if the sender has permitted such behavior.

The case when a mail has several recipients is straightforward: Sequential key queries shall be performed for all intended mail recipients, and the sender shall be asked about unencrypted mail transfer to those recipients for whom no key could be retrieved. A local certificate store may be included at any point in the key query sequence.

For the case when another person has obtained the private key associated with an email address, the owner of the email address or the owner of the email address' domain may request discontinuation of the email address and deletion of the corresponding public key entry from the key server. Or the owner of the email address may request generation and delivery of a new private/public key pair and the registration of the new public key on the key server or the key servers. This may become necessary when the private key of an email owner has been spied out by other persons. Therefore, a web-based user account would be setup in such a way that the authenticated user would be able to revoke the current public/private key pair and to regenerate a new public/private key pair for his e-mail address.

Typically, if the owner of an email address domain would find out that the email address is used for spamming or that the private key associated with that email address is published on the internet, the domain owner would notify the email address owner to request new key generation. If the email address owner does not react to this notification for a set period of time, the domain owner might discontinue the email address to avoid being blacklisted as a spamming domain.

Additionally, while the embodiments herein show specific configurations of email software to access POP or Exchange Email servers with proper authentication, it is to be understood that different configurations of email systems such as Web-based email are contemplated by applying an applet to a web-based e-mail in order to perform public key lookup and message encryption on the transmitting side, and an applet to perform private key lookup from a private store and message decryption. By the same token, it is to be understood that the teachings herein can be more broadly applied to other types of similar application requiring transmission and reception of secure emails.

Deliver secure e-mail client software on a portable memory device such as a USB stick to provide secure e-mail service in a way of independent of computer hardware. This storage of secure e-mail software enables the offering of secure e-mail service in a public computer environment, such as an Internet Café or a hotel.

Private Keys can be stored in a secure database without any association of public keys or e-mail address to facilitate law enforcement unit to decrypt selected e-mails under warren with linear effort.

The above-described embodiments of the invention are intended to be examples of the present invention and alterations and modifications may be effected thereto, by those of skill in the art, without departing from the scope of the invention which is defined solely by the claims appended hereto.

### INDUSTRIAL APPLICABILITY

By allowing for individual registration without the need of certificates, and by defining a distributed hierarchical infrastructure of key servers, secure email communication between users from different organizations and different domains will be greatly facilitated.

When using a Web mail client, users can enjoy secure email communication while they write and send emails exactly like before when unsecured (plain) email sending was the only option offered to them.

When using a local mail client, users only have to install an plug-in to their mail client, and then can enjoy secure email communication while they write and send emails exactly like before when unsecured (plain) email sending was the only option offered to them.

By simplification of key request, delivery and retrieval will be the decisive step to widespread use of secure email communication.

1. A system for providing a service to register email addresses and generate public/private key pairs for those email addresses so that they can be used for secure email communication, and for providing a service to automatically retrieve public keys for recipient email addresses and use them for encrypting emails sent to recipients.
The system comprises
a registration server which
accepts registration requests for a particular email address,
checks for availability of the email address,
enters a requested available email address into the mail server database,
triggers public/private key generation for the mail address,
triggers production of a customized software package containing the public/private key pair and mail agents for the user's favorite mail clients
offers delivery of that software package to the user
a key server which
stores email addresses and the public keys associated with them
responds to requests for the public key associated with an email address
optional mail servers to provide the standard email service for one or several domains

2. A system according to claim 1, wherein the registration server is accessible from the Internet to enable self registration of email addresses by users

3. A system according to claim 1, wherein the registration server and/or the mail server and/or the key server are implemented as server farms, the nodes of the server farm optionally being distributed to achieve high reliability even in disaster situations.

4. A system according to claim 1, wherein the key server is implemented hierarchically, with the topmost hierarchies acting as directory servers which redirect public key requests to the appropriate key servers. The directory servers may redirect based on the full email address for which a public key is requested, on the email domain or part of the email domain. The directory servers may themselves form a hierarchy with the topmost directory server level resolving higher level domains and the lower directory server levels resolving subdomains or specific email addresses.

5. A system according to claim 4, wherein the key server hierarchy follows the domain name service (DNS) hierarchy, i.e. each domain owner may offer a public key server service under a specified port for email addresses within his domain(s).

6. A system according to claim 4, wherein the key server hierarchy can be detected according to a variant of the domain name service (DNS) service that is clearly distinct from the domain name service itself. Thereby existing key servers can act as delegates for domains whose owner does not offer public key server service.

7. A system combining the functionality of the systems according to claims 5 and 6, in a way that the public key for a particular email address is requested from the domain owner first, and from other key servers when the request to the domain owner has failed.

8. A system according to claim 4, wherein the directory servers respond to the request with a preliminary answer, indicating the key server or the key server farm where the public key will be stored if the email address exists and has a public key associated with it. In this implementation, the requesting agent has to send a second request for a public key directly to the indicated key server.

9. A system according to claim 1, wherein the owner of the email address is allowed to request generation of a new private/public key pair for this email address.

10. A system according to claim 1, wherein the key server signs public keys with its private key to inhibit modification of the public key on the way to the requestor.

11. A system according to claim 1, wherein the key server requires requests to contain not only the email address for which the public key is requested, but also an email address of the requestor which is associated with a public key. The key server will then encrypt the requested public key with the public key of the requestor, so that the requested public key can only be retrieved with the help of the requestor's private key. If the key server does not know the public key of the requester, it can itself send a request to the key server hierarchy and receive a response encrypted with the key server's public key.

12. A system according to claim 1, wherein the registration server does not provide a customized software package with a mail client plug-in, but stores the private key on a trusted key server, asking the user to employ a server based mail client which will contact the trusted private key server when it receives encrypted email for that user.

13. A system according to claim 1, wherein the registration server provides the generation of a public/private key pair for an existing email address, provided that the requestor can authenticate herself as the owner of this email address. Consequent actions, i.e. entry of the public does not provide a customized software package with a mail client plug-in, but stores the private key on a trusted key server, asking the user to employ a server based mail client which will contact the trusted private key server when it receives encrypted email for that user.

14. A system according to claim 1, wherein the key server generates a certificate along with the public/private key pair to allow for the inclusion of the key in certificate stores.

15. A system according to claim 1, wherein the software package delivered to the user holds an additional program to generate external media such as USB keys, writeable disks or memory cards which hold the private key in a secure way. After generation of the external media, the private key can be deleted from the client computer, and applications using the private key can be directed to the external media.

16. A system according to claim 14, wherein the software package delivered to the user does not require installation and/or is ready to run from a removable device which can be used in any computer supporting the removable device interface and running a compatible operating system, virtual machine or emulator.

17. A system according to claim 1, wherein the mail client plug-in or the server based mail client gives the user feedback on the security status of the mail before sending it, allowing the user to make a decision about sending the mail and about deletions or modifications to recipient addresses before sending. The feedback can be suppressed if all recipients support secure email.

18. A system according to claim 1, where private keys are stored in a secure data base without any association of public keys or e-mail address to facilitate law enforcement, law enforcement unit having to try out private keys to decrypt selected e-mails under warren with linear effort.

19. A system according to claim 1 which delivers secure mail client software on a portable memory device such as a USB stick to provide secure e-mail service in a way of independent of computer hardware. This enable offering of secure e-mail service in public computer environment.

20. A system according to claim 1 which applies applet to a web-based e-mail in order to perform public key lookup and message encryption and to perform message decryption using the user's private key.
